(19) United States
(12) Patent Application Publication
(10) Pub. No.: US 2021/0390560 A1
(43) Pub. Date: Dec. 16, 2021

(54) INFORMATION PROCESSING APPARATUS AND CONTROL PROGRAM THEREFOR

(71) Applicant: TOSHIBA TEC KABUSHIKI KAISHA, Tokyo (JP)

(72) Inventors: Hirofumi KOJIMA, Fukuoka (JP); Yuusuke KAWAIDA, Fukuoka (JP)

(73) Assignee: TOSHIBA TEC KABUSHIKI KAISHA, Tokyo (JP)

(21) Appl. No.: 17/150,705

(22) Filed: Jan. 15, 2021

(30) Foreign Application Priority Data
Jun. 10, 2020 (JP) 2020-100946

(51) Int. Cl. G06Q 30/02; G06Q 30/06; G06Q 20/20; G06Q 20/38

(52) U.S. Cl. CPC G06Q 30/02; G06Q 20/387; G06Q 20/20; G06Q 30/06

(57) ABSTRACT

An information processing apparatus acquires a code including first data for identifying a consumer and second data for specifying information to be provided for a purchase action. The information processing apparatus acquires the first data and the second data from the acquired code. The information processing apparatus provides the information specified by the second data acquired together with the first data to the consumer identified by the acquired first data.

### CROSS-REFERENCE TO RELATED APPLICATION

This application is based upon and claims the benefit of priority from Japanese Patent Application No. 2020-100946, filed on Jun. 10, 2020, the entire contents of which are incorporated herein by reference.

### FIELD

Embodiments described herein relate generally to an information processing apparatus and a control program therefor.

### BACKGROUND

In recent years, many stores carry out services for consumers using smartphones. For example, there is a service for registering, as a points member, a consumer who performs member registration from a dedicated application program installed on a smartphone by the consumer. The consumer registered as the points member presents, in connection with payment in a store, a member code displayed on the smartphone by action of the application program. Consequently, the consumer can acquire, for example, a service point corresponding to a purchase amount.

The consumer can also obtain a coupon relating to a privilege extended to the consumer by the store that is associated with a commodity via the application program (e.g., a benefit to which the consumer is privileged). During payment in the store, by presenting the coupon displayed on the smartphone, the consumer can purchase a commodity corresponding to the coupon at a cut or discounted price.

If the consumer registered as the points member uses the coupon, however the consumer is requested to perform an operation for presenting the coupon separately from an operation for presenting the member code on the smartphone. Therefore, many consumers feel that the operation is complicated. A store clerk has to respectively confirm information of the member code and information of the coupon displayed on the smartphone and input the information to a POS (Point Of Sales) terminal. Therefore, a large burden is placed on the store clerk.

Related art is described in, for example, JP-A-2002-260099.

### DESCRIPTION OF THE DRAWINGS

FIG. 1 is a schematic configuration diagram of an information processing system including a POS terminal in at least one embodiment;

FIG. 2 is a schematic diagram illustrating a main data structure of a coupon record saved in a coupon database;

FIG. 3 is a schematic diagram illustrating a main data structure of a member record saved in a member database;

FIG. 4 is a block diagram illustrating a main circuit configuration of a sales promotion server;

FIG. 5 is a block diagram illustrating a main circuit configuration of a POS terminal;

FIG. 6 is a flowchart illustrating a main procedure of a sales promotion code creating process executed by a processor of the sales promotion server according to at least one embodiment;

FIG. 7 is a flowchart illustrating a main procedure of a payment process executed by a processor of the POS terminal according to at least one embodiment;

FIG. 8 is a flowchart illustrating a main procedure of a subtotaling process executed by the processor of the POS terminal according to at least one embodiment;

FIG. 9 is a flowchart illustrating a main procedure of a sales promotion preprocess executed by the processor of the POS terminal according to at least one embodiment;

FIG. 10 is a flowchart illustrating a main procedure of a sales promotion process executed by the processor of the POS terminal according to at least one embodiment;

FIG. 11 is a flowchart illustrating a main procedure of sales promotion data receiving process executed by the processor of the sales promotion server according to at least one embodiment;

FIG. 12 is a schematic diagram illustrating an example of a sales promotion code;

FIG. 13 is a schematic diagram illustrating an example of an image for notifying a consumer that a coupon is unused;

FIG. 14 is a schematic diagram illustrating a data structure of a member record in a second embodiment;

FIG. 15 is a schematic diagram illustrating an example of a data table;

FIG. 16 is a flowchart illustrating a main procedure of a sales promotion code creating process executed by a processor of a sales promotion server in the second embodiment;

FIG. 17 is a schematic diagram illustrating an example of a sales promotion code in the second embodiment; and

FIG. 18 is a schematic diagram illustrating another example of the sales promotion code.

### DETAILED DESCRIPTION

An object of at least one embodiment is to provide an information processing apparatus that can reduce or eliminate a feeling of complexity of a consumer and reduce a burden on a store clerk.

According to at least one embodiment, an information processing apparatus includes a first acquiring unit (processor), a second acquiring unit (processor), and a providing unit (processor). The first acquiring unit acquires a code including first data for identifying a consumer and second data for specifying information to be provided for a purchase action. The second acquiring unit acquires the first data and the second data from the code acquired by the first acquiring unit. The providing unit provides the information specified by the second data acquired by the second acquiring unit together with the first data to the consumer identified by the first data acquired by the second acquiring unit.

At least one embodiment of an information processing apparatus is explained below with reference to the drawings. In the embodiments explained below, a face to face POS terminal is an example of the information processing apparatus.

### First Embodiment

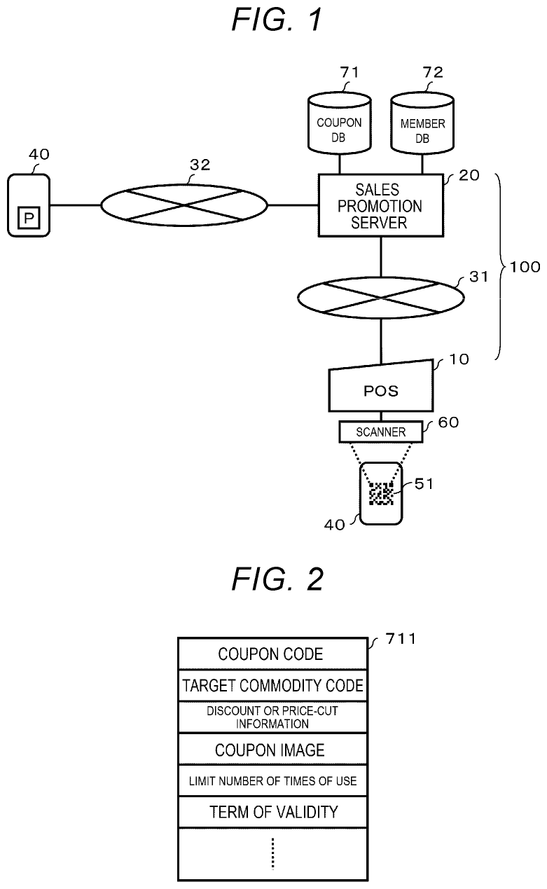

First, a first embodiment is explained with reference to FIGS. 1 to 13.

FIG. 1 is a schematic configuration diagram of an information processing system 100 including a POS terminal 10 functioning as an information processing apparatus. The information processing system 100 includes the POS terminal 10, a sales promotion server 20, and a first communication network 31. In the information processing system 100, the POS terminal 10 and the sales promotion server 20 are connected to the first communication network 31. The number of POS terminals 10 connected to the first communication network 31 is not particularly limited. A plurality of POS terminals 10 may be connected to the first communication network 31. The first communication network 31 is, for example, a LAN (Local Area Network). The first communication network 31 may include the Internet or a WAN (Wide Area Network).

The POS terminal 10 has a function of registering sales data of a commodity to be purchased by a consumer and calculating a settlement amount of a commercial transaction and a function of processing a price payment by the consumer for the settlement amount, and settling the commercial transaction. The POS terminal 10 is typically set in a register (a payment place) of a store.

The sales promotion server 20 is a computer for server specialized for providing a sales promotion service to consumers via the POS terminal 10. The sales promotion service includes a point granting service. The point granting service is a service for granting a point corresponding to a purchase amount to a consumer registered as a points member. The consumer can save granted points. The consumer can use the saved points for, for example, payment of a price.

The sales promotion service includes a coupon issuing service as well. The coupon issuing service is a service for issuing a coupon relating to a privilege of a commodity to the consumer registered as the points member. The consumer can purchase a commodity corresponding to the coupon at a cut or discounted price. The coupon is an example of information provided to the consumer for a purchase action of the consumer.

The sales promotion server 20 is set in, for example, an office of the store or a head office. The sales promotion server 20 may be set in an operating company of a sales promotion service having a contract with the store or the head office. The sales promotion server 20 may be a cloud computing server that provides the sales promotion service.

The sales promotion server 20 is also connected to a second communication network 32 usable by a general-purpose communication terminal 40. The second communication network 32 is, for example, the Internet. The second communication network 32 may include a telephone communication network or a mobile communication network. Alternatively, the second communication network 32 may be a combination of the telephone communication network and the mobile communication network.

The communication terminal 40 is a portable communication device such as a smartphone or a tablet. A user of the communication terminal 40 is a consumer who is a points member of a store where the POS terminal 10 is operating. A consumer desiring to be a points member installs a dedicated application program in the communication terminal 40. In the following description, the application program is referred to as a member application P. The consumer, who installed the member application P, starts the member application P and performs member registration first. According to the member registration, a specific member code is allocated to the consumer. In the communication terminal 40 of the consumer who finished the member registration, a sales promotion code 51 in a two-dimensional code scheme is sometimes displayed on a display device. The sales promotion code 51 includes information of the member code. The sales promotion code 51 includes information other than the member code. Details of the information are explained below. The POS terminal 10 includes a scanner 60 capable of reading the sales promotion code 51.

The sales promotion server 20 manages a coupon database 71 and a member database 72. The coupon database 71 is an aggregate of coupon records 711 (see FIG. 2) generated for each of coupons.

FIG. 2 is a schematic diagram illustrating a main data structure of the coupon record 711. As illustrated in FIG. 2, the coupon record 711 includes a coupon code, a target commodity code, discount or price-cut information, a coupon image, a limit number of times of use, and a term of validity.

The coupon code is a unique code set for each of coupons in order to individually identify various coupons. The target commodity code is a commodity code of a commodity price-cut or discounted by the coupon identified by the coupon code. The discount or price-cut information is an amount reduced by the coupon (a price-cut amount) or a discount rate applied by the coupon. The coupon image is image data including an image of a target commodity of the coupon and a text indicating the price-cut amount or the discount rate. The limit number of times of use is the number of times of use of the coupon allowed for one user. For example, for a coupon that can be used only once, the limit number of times of use is set to “1”. For example, for a coupon usable up to three times, the limit number of times of use is set to “3”. For a coupon that can be used without limitation, the limit number of times of use is set to “0”. The term of validity is data for specifying a period in which the coupon is valid. For example, the term of validity is data representing a start date and an end date of a valid period. For example, the term of validity may be only data representing the end date of the valid period. For example, the term of validity may be data representing the start date and the valid period.

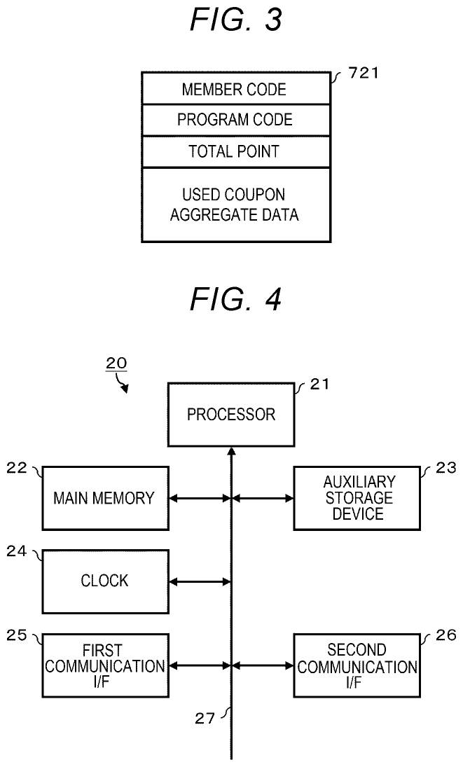

The member database 72 is an aggregate of member records 721 (see FIG. 3).

FIG. 3 is a schematic diagram illustrating a main data structure of the member record 721. As illustrated in FIG. 3, the member record 721 includes a member code, a program code, a total point, and used coupon aggregate data.

The member code is a unique code allocated to each consumer registered as a points member. The program code is an identification code of the member application P installed in the communication terminal 40 by the consumer. The total point is a total value of service points granted to the consumer. The used coupon aggregate data is a set of pair data of coupon codes of coupons used by the consumer and the number of times of use.

FIG. 4 is a block diagram illustrating a main circuit configuration of the sales promotion server 20. The sales promotion server 20 includes a processor 21, a main memory 22, an auxiliary storage device 23, a clock 24, a first communication interface (I/F) 25, and a second communication interface 26. In the sales promotion server 20, the processor 21, the main memory 22, the auxiliary storage device 23, the clock 24, the first communication interface 25, and the second communication interface 26 may be connected by a system bus 27. The system bus 27 may include an address bus and a data bus. In the sales promotion server 20, a computer is configured by connecting the processor 21, the main memory 22, and the auxiliary storage device 23 with the system bus 27.

The processor 21 is equivalent to a central part of the computer. The processor 21 controls the units according to an operating system or application programs in order to realize various functions of the sales promotion server 20. The processor 21 is, for example, a CPU (Central Processing Unit).

The main memory 22 is equivalent to a main storage part of the computer. The main memory 22 includes a nonvolatile memory region and a volatile memory region. The main memory 22 stores the operating system or the application programs in the nonvolatile memory region. The main memory 22 stores, in the volatile memory region, data necessary for the processor 21 in executing a process for controlling the sections. The main memory 22 uses the volatile memory region as a work area where data is rewritten as appropriate by the processor 21. The nonvolatile memory region is, for example, a ROM (Read Only Memory). The volatile memory region is, for example, a RAM (Random Access Memory).

The auxiliary storage device 23 is equivalent to an auxiliary storage part of the computer. As the auxiliary storage device 23, a well-known device such as an EEPROM (Electric Erasable Programmable Read-Only Memory), an HDD (Hard Disc Drive), or an SSD (Solid State Drive) can be used alone or a plurality of thereof can be used in combination. The auxiliary storage device 23 saves data to be used by the processor 21 in performing various kinds of processes, data generated by the process in the processor 21, or the like. The auxiliary storage device 23 sometimes stores the application programs.

The application programs stored by the main memory 22 or the auxiliary storage device 23 include a control program explained below. A method of installing the control program in the main memory 22 or the auxiliary storage device 23 is not particularly limited. The control program can be installed in the main memory 22 or the auxiliary storage device 23 by being recorded in a removable recording medium or being distributed by communication via a network. A form of the recording medium may be any form if the recording medium can store programs and can be read by a device like a CD-ROM, a memory card, or the like.

The clock 24 functions as a time information source of the sales promotion server 20. The processor 21 clocks a present date and time based on time information clocked by the clock 24.

The first communication interface 25 is a circuit for performing data communication with the POS terminal 10 connected to the first communication interface 25 via the first communication network 31.

The second communication interface 26 is a circuit for performing data communication with the communication terminal 40 connected to the second communication interface 26 via the second communication network 32.

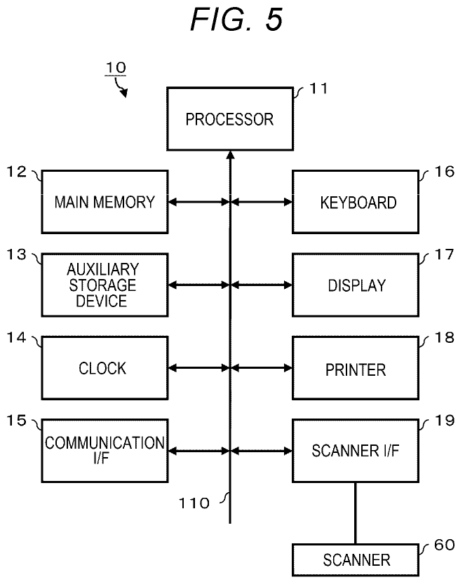

FIG. 5 is a block diagram illustrating a main circuit configuration of the POS terminal 10, for example. The POS terminal 10 includes a processor 11, a main memory 12, an auxiliary storage device 13, a clock 14, a communication interface 15, a keyboard 16, a display 17, a printer 18, and a scanner interface 19. In the POS terminal 10, the processor 11, the main memory 12, the auxiliary storage device 13, the clock 14, the communication interface 15, the keyboard 16, the display 17, the printer 18, and the scanner interface 19 are connected by a system bus 110. The system bus 110 may include an address bus and a data bus. In the POS terminal 10, a computer is configured by connecting the processor 11, the main memory 12 and the auxiliary storage device 13 with the system bus 110.

The processor 11 is equivalent to a central part of the computer. The processor 11 controls the units according to an operating system or application programs in order to realize various functions of the POS terminal 10. The processor 21 is, for example, a CPU.

The main memory 12 is equivalent to a main storage part of the computer. The main memory 12 includes a nonvolatile memory region and a volatile memory region. The main memory 12 stores the operating system or the application programs in the nonvolatile memory region. The main memory 12 stores, in the volatile memory region, data necessary for the processor 11 in executing a process for controlling the units. The main memory 12 uses the volatile memory region as a work area where data is rewritten as appropriate by the processor 11. The nonvolatile memory region may be, for example, a ROM. The volatile memory region may be, for example, a RAM.

The auxiliary storage device 13 is equivalent to an auxiliary storage part of the computer. As the auxiliary storage device 13, a well-known device such as an EEPROM, an HDD, or an SSD can be used alone or a plurality of thereof can be used in combination. The auxiliary storage device 13 saves data to be used by the processor 11 in performing various kinds of processes, data generated by the process in the processor 11, or the like. The auxiliary storage device 13 sometimes stores the application programs.

The application programs stored by the main memory 12 or the auxiliary storage device 13 include a control program explained below. A method of installing the control program in the main memory 12 or the auxiliary storage device 13 is not particularly limited. The control program can be installed in the main memory 12 or the auxiliary storage device 13 by being recorded in a removable recording medium or being distributed by communication via a network. A form of the recording medium may be any form if the recording medium can store programs and can be read by a device such as a CD-ROM, a memory card, or the like.

The clock 14 functions as a time information source of the POS terminal 10. The processor 11 clocks a present date and time based on time information clocked by the clock 14.

The communication interface 15 is a circuit for performing data communication with the sales promotion server 20 connected to the communication interface 15 via the first communication network 31.

The keyboard 16 is an input device on which, besides numeric keys for registering numerical values such as the number of items, an amount, and a commodity code, various function keys such as a multiplication key, a subtotal key, and closing keys. The subtotal key is a key for instructing a subtotal output of a commercial transaction. The closing keys are keys for instructing registration closing of the commercial transaction. The closing keys are prepared for each of settlement methods. That is, a closing key for cash settlement, a closing key for point settlement, a closing key for credit settlement, a closing key for electronic money settlement, a closing key for code settlement, and the like are disposed on the keyboard 16.

The display 17 is an output device for displaying a name (a commodity name), a price, a total amount, a change amount, and the like of a commodity registered by the POS terminal 10. As the display 17, there are two types, that is, a display for store clerks who operate the POS terminal 10 and a display for consumers who operate the POS terminal 10. A touch panel used as both of the input device and the output device may be applied instead of the keyboard 16 and the display 17.

The printer 18 is an output device for outputting receipt data representing details of a commercial transaction to print the receipt data on predetermined receipt paper. The receipt paper on which the receipt data is printed is cut by a cutter and dispensed as a paper receipt.

The scanner interface 19 is for communication with the scanner 60. The scanner 60 is provided for reading of a barcode or a two-dimensional code attached to a commodity, for example. Barcodes or two-dimensional codes indicating commodity codes specific to commodities are attached to the commodities. The scanner 60 is also provided for reading of the sales promotion code 51 displayed on a touch panel of the communication terminal 40 carried by the consumer. The scanner 60 is a handy-type scanner for store clerk operation. The scanner 60 may include a self-service scanner over which the consumer himself or herself holds the sales promotion code 51 displayed on the touch panel of the communication terminal 40 to cause the self-service scanner to read the sales promotion code 51.

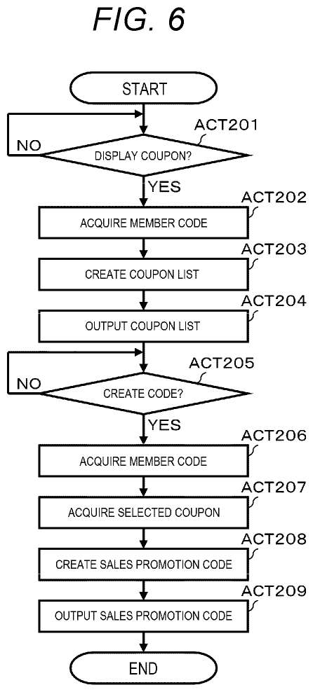

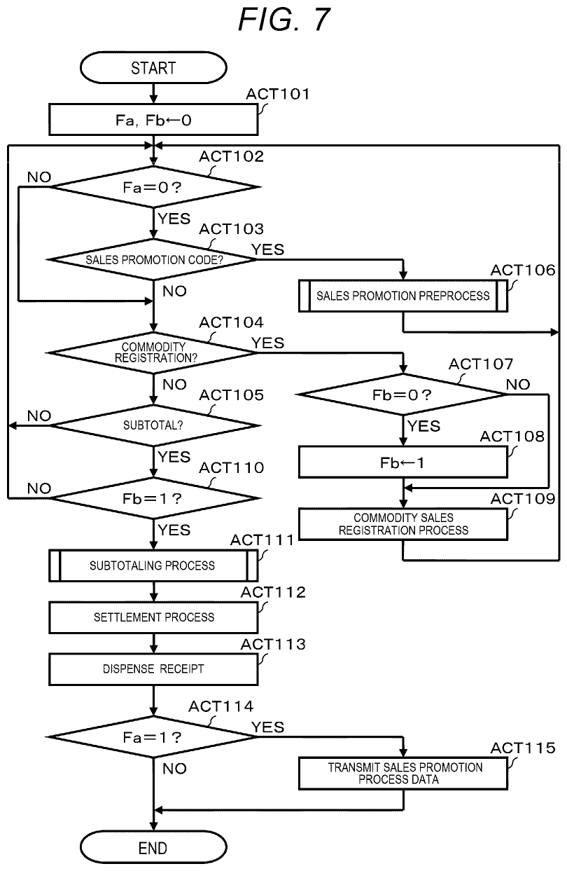

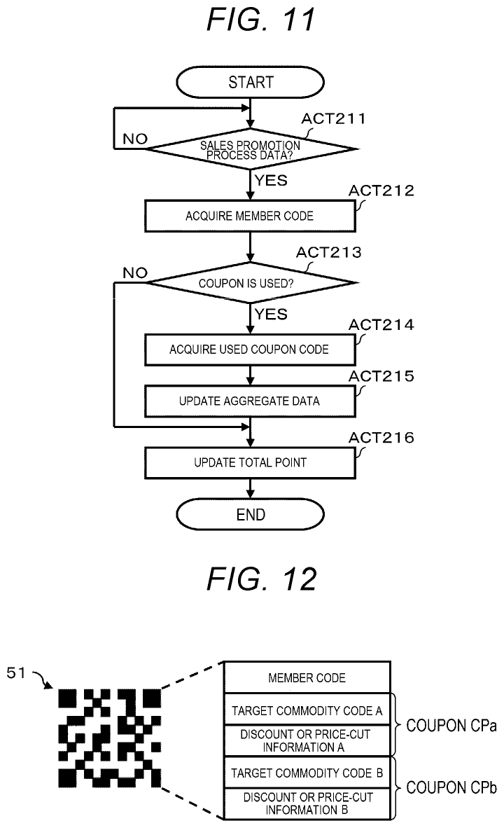

FIGS. 6 and 11 are flowcharts illustrating procedures of information processing executed by the processor 21 of the sales promotion server 20 according to the control program. FIGS. 7 to 10 are flowcharts illustrating procedures of information processing executed by the processor 11 of the POS terminal 10 according to the control program. Main operations of the sales promotion server 20 and the POS terminal 10 are explained below with reference to these flowcharts. The operations explained below are examples. The procedures and the like of the operations are not particularly limited if the same results can be obtained.

FIG. 6 is a flowchart illustrating a main procedures of a sales promotion code creating process executed by the processor 21 of the sales promotion server 20. In ACT 201, the processor 21 waits for a coupon displaying command.

The coupon displaying command is output from the communication terminal 40 carried by a consumer registered as a member. For example, if the consumer operates the communication terminal 40 to start the member application P, a menu screen is displayed on the touch panel of the communication terminal 40. Therefore, the consumer selects a coupon display menu from the menu screen. Then, a coupon display command is output from the communication terminal 40 to the sales promotion server 20. The coupon display command is transmitted to the sales promotion server 20 via the second communication network 32. The coupon display command includes a member code of a member, who is a user of the communication terminal 40. The coupon display command may include a program code of the member application P installed in the communication terminal 40.

If receiving the coupon display command via the second communication interface 26, the processor 21 of the sales promotion server 20 determines YES in ACT 201 and proceeds to ACT 202. In ACT 202, the processor 21 acquires the member code from the coupon display command. The processor 21 may acquire the program code from the coupon display command.

In ACT 203, the processor 21 creates a coupon list. Specifically, first, the processor 21 searches through the coupon database 71 with present dates clocked by the clock 24 and extracts the coupon records 711, present dates of which are within a term of validity. Subsequently, the processor 21 searches through the member database 72 with member codes or program codes acquired in the process in ACT 202 and acquires used coupon aggregate data from the member records 721 including the member codes or the program codes. The processor 21 excludes the coupon records 711, in which the numbers of times of use exceeds the limit number of times of use, from the coupon records 711 extracted from the coupon database 71. The processor 21 creates a coupon list with coupon codes and coupon images of the remaining coupon records 711.

In ACT 204, the processor 21, which created the coupon list in this way, outputs data of the coupon list to the communication terminal 40 which is a coupon display command transmission source. Consequently, the data of the coupon list is transmitted to the communication terminal 40 via the second communication network 32. The coupon list is displayed on the touch panel of the communication terminal 40.

Therefore, the consumer selects a coupon that the consumer desires to use in shopping out of the coupon list. The consumer can select one or more coupons. If finishing selecting the coupon, the consumer instructs code creation. A code creation button is displayed on the coupon list together with the coupon images. The consumer, who finished selecting the coupon, touches the code creation button and instructs the code creation. If the code creation button is touched, a code creation command is output from the communication terminal 40 to the sales promotion server 20. The code creation command is transmitted to the sales promotion server 20 via the second communication network 32. The code creation command includes, together with a member code, a coupon code of the coupon selected by the consumer.

In ACT 205, the processor 21 of the sales promotion server 20, which controlled the output of the coupon list, waits for the code creation command. If receiving the code creation command from the communication terminal 40 at a coupon list output destination, the processor 21 determines YES in ACT 205 and proceeds to ACT 206. In ACT 206, the processor 21 acquires the member code from the code creation command. In ACT 207, the processor 21 acquires the coupon code from the code creation command. At this time, if the code creation command includes two or more coupon codes, the processor 21 acquires all the coupon codes. In some case, the consumer selects no coupon. In that case, the processor 21 does not acquire a coupon code.

In ACT 208, the processor 21 creates the sales promotion code 51. The sales promotion code 51 is a code in a two-dimensional code scheme. An example of the sales promotion code 51 is illustrated in FIG. 12. The sales promotion code 51 illustrated in FIG. 12 is a sales promotion code created for a consumer who selects, from the coupon list, a coupon CPa of a commodity specified by a target commodity code A and a coupon CPb of a commodity specified by a target commodity code B. As illustrated in FIG. 12, the sales promotion code 51 includes a member code, the target commodity code A and discount or price-cut information A of the coupon CPa, and the target commodity code B and discount or price-cut information B of the coupon CPb.

For a consumer who selected three or more kinds of coupons, the sales promotion code 51 including target commodity codes and discount or price-cut information of the three or more kinds of coupons together with a member code is created. Fora consumer who selected one kind of a coupon, the sales promotion code 51 including a target commodity code and discount or price-cut information of the one kind of the coupon together with a member code is created. For a consumer who did not select a coupon, the sales promotion code 51 including only a member code is created.

In ACT 209, the processor 21, which finished creating the sales promotion code 51, outputs data including the sales promotion code 51 to the communication terminal 40 which is a code creation command transmission source. Consequently, the data including the sales promotion code 51 is transmitted to the communication terminal 40 which is the code creation command transmission source via the second communication network 32. As a result, the sales promotion code 51 is displayed on the touch panel of the communication terminal 40. Therefore, the consumer, who confirmed the sales promotion code 51, performs shopping (shops) in the store. If finishing the shopping, the consumer goes to a register, presents the sales promotion code 51 together with commodities to be purchased, and performs payment.

Timing for instructing the creation of the sales promotion code 51 is not limited to timing before the consumer starts shopping. For example, the consumer may confirm the coupon list, select a desired coupon, and instruct the creation of the sales promotion code 51 halfway through the shopping. For example, the consumer may confirm the coupon list, select a desired coupon, and instruct the creation of the sales promotion code 51 during registration of the purchased commodity in the POS terminal 10. In short, before registration closing is declared, the consumer can instruct the creation of the sales promotion code 51.

FIG. 7 is a flowchart illustrating a main procedure of a payment process executed by the processor 11 of the POS terminal 10. If starting the payment process, in ACT 101, the processor 11 resets a first flag Fa and a second flag Fb to “0”. The first flag Fa is one-bit data for identifying whether a transaction is a member transaction. The second flag Fb is one-bit data for identifying whether purchased commodity registration for one commercial transaction is being performed. The first flag Fa and the second flag Fb are stored in the main memory 12.

In ACT 102, the processor 11 confirms whether the first flag Fa has been reset. Since the first flag Fa has been reset in the beginning, the processor 11 determines YES in ACT 102 and proceeds to ACT 103. In ACT 103, the processor 11 confirms whether the sales promotion code 51 has been read. If the sales promotion code 51 has not been read, the processor 11 determines NO in ACT 103 and proceeds to ACT 104. In ACT 104, the processor 11 confirms whether commodity registration has been performed. If commodity registration has not been performed, the processor 11 determines NO in ACT 104 and proceeds to ACT 105. In ACT 105, the processor 11 confirms whether a subtotal output has been instructed. If the subtotal output has not been instructed, the processor 11 determines NO in ACT 105 and returns to ACT 102. If the first flag Fa has been reset, in ACT 103 to ACT 105, the processor 11 waits for the sales promotion code 51 to be read, commodity registration to be performed, and a subtotal instruction to be input.

The consumer, who has already created the sales promotion code 51, presents the sales promotion code 51 to the store clerk. The store clerk reads the sales promotion code 51 presented from the consumer with the scanner 60. Alternatively, the consumer himself or herself reads the sales promotion code 51 using the scanner 60.

In the waiting state in ACT 103 to ACT 105, if confirming that the sales promotion code 51 has been read, the processor 11 determines YES in ACT 103 and proceeds to ACT 106. In ACT 106, the processor 11 executes a sales promotion preprocess. Details of the sales promotion preprocess are explained below. In the sales promotion preprocess, the first flag Fa is sometimes set to “1”.

If finishing the sales promotion preprocess, the processor 11 returns to ACT 102. If the first flag Fa has been set to “1”, the processor 11 determines NO in ACT 102 and proceeds to ACT 104. If the first flag Fa has been set, in ACT 104 and ACT 105, the processor 11 waits for commodity registration to be performed or the subtotal instruction to be input.

The store clerk reads a barcode attached to a purchased commodity of the consumer with the scanner 60. If a barcode is not attached to the commodity, the store clerk operates the keyboard 16 to input a commodity code.

If the barcode of the commodity is read by the scanner 60 or the commodity code is input via the keyboard 16, the processor 11 recognizes that commodity registration has been performed. In the waiting state in ACT 103 to ACT 105 or the waiting state in ACT 104 and ACT 105, if recognizing that the commodity registration has been performed, the processor 11 determines YES in ACT 104 and proceeds to ACT 107.

In ACT 107, the processor 11 confirms whether the second flag Fb has been reset. Since the second flag Fb is reset in the beginning, the processor 11 determines YES in ACT 107 and proceeds to ACT 108. In ACT 108, the processor 11 sets the second flag Fb to “1”.

Thereafter, in ACT 109, the processor 11 executes a commodity sales registration process. That is, the processor 11 acquires, from a commodity master, commodity data such as a unit price and a commodity name of the commodity identified by the commodity code input in the commodity registration. The processor 11 calculates, from the unit price and the number of sold items, a price for the number of sold items, that is, a sales amount. If a multiplier has been input via the keyboard 16 before the commodity registration, the number of sold items is the multiplier. If a multiplier has not been input, the number of sold items is “1”. The processor 11 creates commodity sales data. The commodity sales data includes a commodity code, a commodity name, a unit price, the number of sold items, and a sales amount. The processor 11 registers the commodity sales data in a transaction memory. The transaction memory is formed in the main memory 12. The transaction memory is cleared, for example, at timing when the first flag Fa and the second flag Fb are reset. The transaction memory is cleared after a transaction data transmitting process explained below.

The processor 11, which finished the commodity registering process, returns to ACT 102. Therefore, in the next commodity registration, since the second flag Fb has been set, the processor 11 determines NO in ACT 107. The processor 11 skips the process in ACT 108 and proceeds to ACT 109. That is, the processor 11 executes the commodity sales registration process. Thereafter, the processor 11 repeatedly executes the commodity sales registration process every time commodity registration is performed.

If finishing registering the purchased commodity of the consumer, the store clerk presses the subtotal key.

If the subtotal key is pressed, the processor 11 recognizes that a subtotal output has been instructed. In the waiting state in ACT 103 to ACT 105 or the waiting state in ACT 104 and ACT 105, if recognizing that the subtotal output has been instructed, the processor 11 determines YES in ACT 105 and proceeds to ACT 110.

In ACT 110, the processor 11 confirms whether the second flag Fb has been set. If the subtotal output is instructed, although commodity registration is not performed, the second flag Fb has not been set. In this case, the processor 11 determines NO in ACT 110 and returns to ACT 102.

If the second flag Fb has been set, the processor 11 determines YES in ACT 110 and proceeds to ACT 111. In ACT 111, the processor 11 executes a subtotaling process. The subtotaling process includes a process for outputting a subtotal amount, which is a settlement amount. Details of the subtotaling process are explained below.

If finishing the subtotaling process, in ACT 112, the processor 11 executes a settlement process for processing a payment for the settlement amount. As the settlement process, there are a settlement process by cash payment, a settlement process by credit card payment, a settlement process by point payment, a settlement process by electronic money payment, a settlement process by code settlement, and the like. Since these settlement processes are well known, detailed explanation of the settlement processes is omitted.

If finishing the settlement process, in ACT 113, the processor 11 controls issuance of a receipt. That is, the processor 11 creates receipt data based on the commodity sales data registered in the transaction memory, processed data of payment for the settlement amount, and the like. The receipt data is output to the printer 18 and dispensed as a paper receipt. Alternatively, the receipt data is transmitted to a receipt server and issued as an electronic receipt. The consumer can view the electronic receipt with the communication terminal 40 or the like by accessing the receipt server.

If finishing issuing the receipt, in ACT 114, the processor 11 confirms whether the first flag Fa has been set. If the first flag Fa has not been set, the processor 11 determines NO in ACT 114 and ends this process.

If the first flag Fa has been set, the processor 11 determines YES in ACT 114 and proceeds to ACT 115. In ACT 115, the processor 11 controls sales promotion process data to be transmitted to the sales promotion server 20. According to this control, the sales promotion process data is transmitted from the communication interface 15 via the first communication network 31 and received by the sales promotion server 20. Details of the sales promotion process data and the operation of the sales promotion server 20, which receives the sales promotion process data, are explained below.

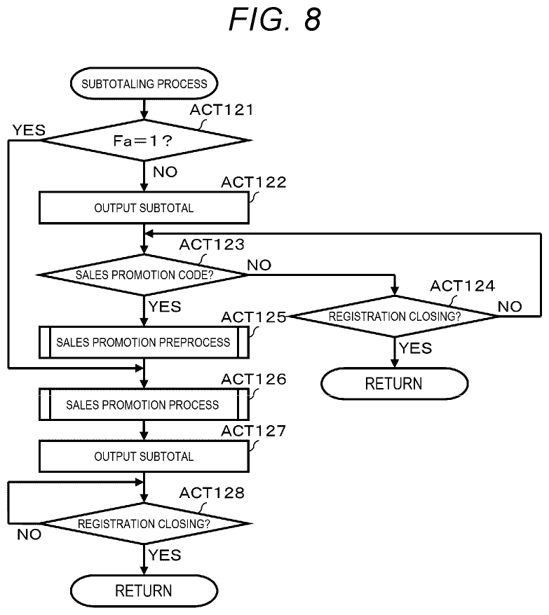

FIG. 8 is a flowchart illustrating a main procedure of the subtotaling process. As explained above, the subtotaling process is executed if the subtotal output is instructed in a state in which the second flag Fb has been set.

If entering the subtotaling process, in ACT 121, the processor 11 confirms whether the first flag Fa has been set. If the first flag Fa has not been set, the processor 11 determines NO in ACT 121 and proceeds to ACT 122. In ACT 122, the processor 11 outputs a subtotal amount. That is, the processor 11 totals sales amounts of the commodity sales data registered in the transaction memory to calculate a subtotal amount and outputs the subtotal amount to display the subtotal amount on the display 17.

If finishing outputting the subtotal amount, in ACT 123, the processor 11 confirms whether the sales promotion code 51 has been read. If the sales promotion code 51 has not been read, the processor 11 determines NO in ACT 123 and proceeds to ACT 124. In ACT 124, the processor 11 confirms whether registration closing has been declared. If the registration closing has not been declared, the processor 11 determines NO in ACT 124 and returns to ACT 123. In ACT 123 and ACT 124, the processor 11 waits for the sales promotion code 51 to be read or the registration closing to be declared.

In the waiting state in ACT 123 and ACT 124, if the registration closing is declared by pressing of any one of the closing keys, the processor 11 determines YES in ACT 124 and leaves the subtotaling process. That is, the processor 11 proceeds to ACT 112 in FIG. 7 and executes the settlement process.

In the waiting state in ACT 123 and ACT 124, if the sales promotion code 51 is read via the scanner 60, the processor 11 determines YES in ACT 123 and proceeds to ACT 125. In ACT 125, the processor 11 executes the sales promotion preprocess described below. If finishing the sales promotion preprocess, the processor 11 proceeds to ACT 126.

On the other hand, if the first flag Fa is already set, the processor 11 determines YES in ACT 121, skips the processes in ACT 122 to ACT 125, and proceeds to ACT 126.

In a state in which the first flag Fa is set in this way, that is, if the sales promotion code 51 has been read before the subtotal instruction, the processor 11 immediately proceeds to ACT 126. In contrast, in a state in which the first flag Fa is reset, that is, if the sales promotion code 51 is not read and the subtotal instruction is preformed, the processor 11 proceeds to ACT 126 if the sales promotion code 51 is read after the subtotal amount output. In ACT 126, the processor 11 executes a sales promotion process. Details of the sales promotion process are described below.

If finishing the sales promotion process, in ACT 127, the processor 11 outputs the subtotal amount. That is, if the sales promotion code 51 has been read before the subtotal instruction, the processor 11 outputs the subtotal amount after executing the sales promotion process. If the sales promotion code 51 is not read and the subtotal instruction is performed and, thereafter, the sales promotion code 51 is read, a sales amount of a purchased commodity could change according to the sales promotion process. Therefore, the processor 11 outputs the subtotal amount again.

If finishing outputting the subtotal amount, in ACT 128, the processor 11 waits for registration closing to be declared. If the registration closing is declared, the processor 11 proceeds to ACT 112 in FIG. 7 and executes the settlement process.

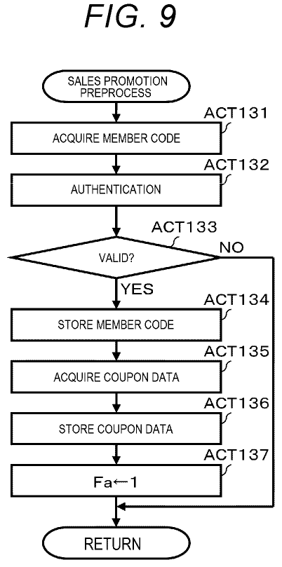

FIG. 9 is a flowchart illustrating a main procedure of the sales promotion preprocess. As described above, the sales promotion preprocess is executed if the sales promotion code 51 is read by the scanner 60.

If entering the sales promotion preprocess, in ACT 131, the processor 11 acquires a member code from the sales promotion code 51. In ACT 132, the processor 11 performs authentication of the member code. Specifically, the processor 11 inquires of the sales promotion server 20 about validity of the member code. The processor 21 of the sales promotion server 20 searches through the member database 72 and confirms whether the member code is valid. The processor 21 returns information indicating whether the member code is valid to the POS terminal 10 at the inquiry source.

In ACT 133, the processor 11, which performed the authentication of the member code, determines whether the member code is valid. If the member code is invalid, the processor 11 determines NO in ACT 133 and ends the sales promotion preprocess. Therefore, in this case, the first flag Fa is still reset to “0”.

On the other hand, if the member code is valid, the processor 11 determines YES in ACT 133 and proceeds to ACT 134. In ACT 134, the processor 11 stores the member code in a sales promotion process memory. The sales promotion process memory is formed in the main memory 12.

In ACT 135, the processor 11, which finished storing the member code, acquires coupon data from the sales promotion code 51. The coupon data is pair data of a target commodity code and discount or price-cut information. If the sales promotion code 51 including two kinds of coupon data is read as illustrated in FIG. 12, the processor 11 acquires the two kinds of coupon data. In ACT 136, the processor 11 stores the coupon data in the sales promotion process memory. Thereafter, in ACT 137, the processor 11 sets the first flag Fa to “1” and ends the sales promotion preprocess.

In this way, according to the execution of the sales promotion preprocess, if a member code acquired from the sales promotion code 51 is valid, the member code is stored in the sales promotion process memory. If coupon data is acquired from the sales promotion code 51, the coupon data is also stored in the sales promotion process memory.

The processor 11 configures a first acquiring unit by executing the process in ACT 103 in cooperation with the scanner 60. That is, the processor 11 acquires, via the scanner 60, the sales promotion code 51 including first data, that is, the member code for identifying the consumer and second data, that is, the coupon data for specifying information provided for a purchase action. The processor 11 configures a second acquiring unit by executing the sales promotion preprocess. That is, the processor 11 acquires the first data, that is, the member code and the second data, that is, the coupon data from the sales promotion code 51 read by the scanner 60.

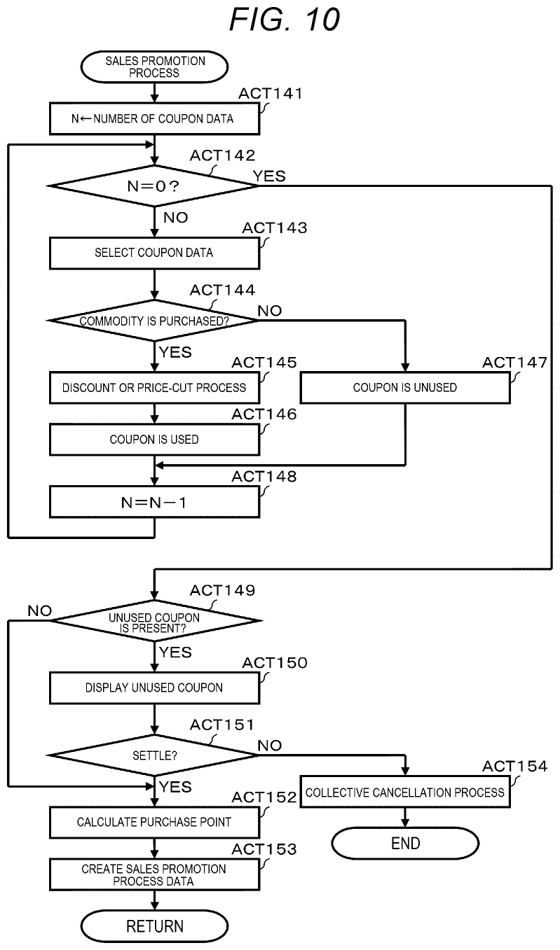

FIG. 10 is a flowchart illustrating a main procedure of the sales promotion process. As described above, the sales promotion process is executed if the subtotal output is instructed in a state in which the first flag Fa has been set, that is, a state in which the sales promotion preprocess has been finished.

In ACT 141, the processor 11 sets, as an initial value of a counter N, a total number of coupon data stored in the sales promotion process memory. The counter N is formed in, for example, the main memory 12. In ACT 142, the processor 11 confirms whether the counter N is “0”. If the counter N is not “0”, the processor 11 determines NO in ACT 142 and proceeds to ACT 143. In ACT 143, the processor 11 selects one of unprocessed coupon data from the sales promotion process memory.

In ACT 144, the processor 11 confirms whether a commodity identified by a target commodity code of the selected coupon data has been purchased. Specifically, the processor 11 confirms whether commodity sales data including the target commodity code has been registered in the transaction memory. If the relevant commodity sales data has been registered, the processor 11 recognizes that the commodity is purchased.

If recognizing that the commodity is purchased, the processor 11 determines YES in ACT 144 and proceeds to ACT 145. In ACT 145, the processor 11 executes a discount or price-cut process. Specifically, the processor 11 cuts or discounts a unit price included in the relevant commodity sales data according to the discount or price-cut information of the coupon data. The processor 11 recalculates a sales amount with the cut or discounted unit price.

If finishing the discount or price-down process, in ACT 146, the processor 11 assumes that the coupon data is used. For example, the processor 11 adds, to the coupon data, a flag indicating that the coupon data is used. Thereafter, the processor 11 proceeds to ACT 148.

On the other hand, if recognizing that the commodity is not purchased, the processor 11 determines NO in ACT 144 and proceeds to ACT 147. In ACT 147, the processor 11 assumes that the coupon data is unused. For example, the processor 11 adds, to the coupon data, a flag indicating that the coupon data is unused. Thereafter, the processor 11 proceeds to ACT 148.

In this way, if adding, to the coupon data selected in ACT 143, the flag indicating that the coupon data is used or unused, the processor 11 proceeds to ACT 148. In ACT 148, the processor 11 counts down the counter N by “1”. The processor 11 returns to ACT 142.

Consequently, the processor 11 repeatedly executes the processes in ACT 143 to ACT 148 until the counter N is counted down to “0”. As a result, the flags indicating that coupon data stored in the sales promotion process memory are used or unused are respectively added to the coupon data.

If confirming that the counter N is “0”, the processor 11 determines YES in ACT 142 and proceeds to ACT 149. In ACT 149, the processor 11 confirms whether coupon data added with the flag indicating that the coupon data is unused is present. If coupon data added with the flag indicating that the coupon data is unused is absent, the processor 11 determines NO in ACT 149 and proceeds to ACT 152.

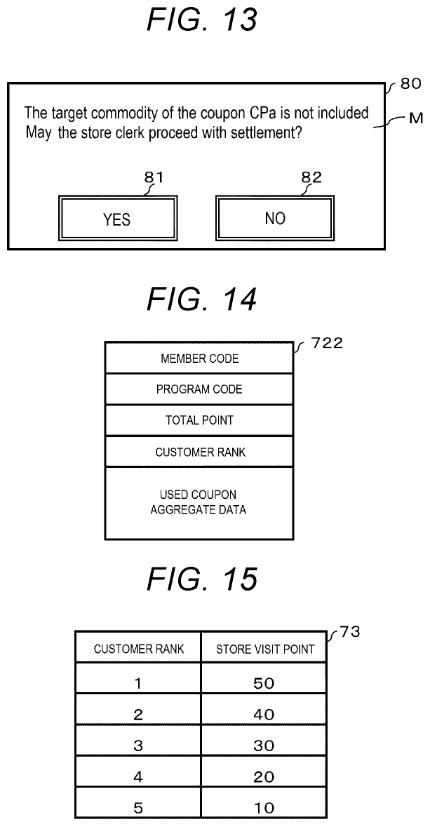

On the other hand, if coupon data added with the flag indicating that the coupon data is unused is present, the processor 11 determines YES in ACT 149 and proceeds to ACT 150. In ACT 150, the processor 11 causes the display 17 to display an image 80 (see FIG. 13) for notifying the consumer that the coupon is unused. The display 17 may be a display for store clerks or may be a display for consumers.

FIG. 13 is an example of the image 80 for notifying the consumer that the coupon is unused. As illustrated in FIG. 13, on the image 80, a “YES” button 81 and a “NO” button 82 are displayed together with a message M for asking the consumer whether the store clerk may proceed with settlement, although the unused coupon is present. If the image 80 is displayed on the display 17 for store clerks, the store clerk asks the consumer whether the store clerk may proceed with settlement, although the unused coupon is present. If the consumer answers that the store clerk may proceed with settlement, the store clerk presses the “YES” button 81. If the consumer answers that the consumer does not want settlement, the store clerk presses the “NO” button 82. If the image 80 is displayed on the display 17 for consumers, the consumer himself or herself presses the “YES” button 81 or the “NO” button 82.

In ACT 151, the processor 11, which caused the display 17 to display the image 80, confirms whether settlement is to be performed or not. If the “YES” button 81 is pressed, the processor 11 recognizes that settlement is to be performed. The processor 11 determines YES in ACT 151 and proceeds to ACT 152.

If unused coupon data is absent in this way or if unused coupon data is present but the consumer answers that the store clerk may proceed with settlement, the processor 11 proceeds to ACT 152. In ACT 152, the processor 11 calculates a purchase point based on the commodity sales data registered in the transaction memory. For example, the processor 11 divides, by a reference amount, a total amount obtained by totaling purchase amounts of respective commodity sales data and sets an integer of the quotient of the division as the purchase point.

If finishing calculating the purchase point, in ACT 153, the processor 11 creates sales promotion process data. The sales promotion process data includes the member code, the coupon data added with the flag indicating that the coupon data is used, and the purchase point. The processor 11, which created the sales promotion process data, proceeds to ACT 127 in FIG. 8.

On the other hand, if the “NO” button 82 is pressed, the processor 11 recognizes that settlement is not performed. The processor 11 determines NO in ACT 151 and proceeds to ACT 154. In ACT 154, the processor 11 executes a collective cancellation process for a commercial transaction. Then, the processor 11 ends this process. In this case, the subtotaling process ends halfway.

The processor 11 configures a providing unit by executing the process in ACT 145. That is, the processor 11 provides, to a consumer identified by first data, that is, a member code acquired by a second acquiring unit, information concerning price-cut or discount specified by second data, that is, coupon data acquired by the second acquiring unit together with the first data.

The processor 11 configures an informing unit by executing the process in ACT 150. That is, if a commodity specified by the second data, that is, the coupon data acquired by the second acquiring unit together with the first data is not included in commodities purchased by the consumer identified by the first data, that is, the member code acquired by the second acquiring unit, the processor 11 informs the consumer to that effect with the display of the image 80.

FIG. 11 is a flowchart illustrating a main procedure of a sales promotion process data receiving process executed by the processor 21 of the sales promotion server 20. In ACT 211, the processor 21 waits for sales promotion process data. If receiving sales promotion process data via the second communication interface 26, in ACT 212, the processor 21 acquires a member code from the sales promotion process data. In ACT 213, the processor 21 confirms whether coupon data added with the flag indicating that the coupon data has been used is present in the sales promotion process data.

If the coupon data is present, in ACT 214, the processor 21 acquires a coupon code of the used coupon data. In ACT 215, the processor 21 updates used coupon aggregate data of the member record 721 including the member code. That is, the processor 21 confirms whether the coupon code of the used coupon data is included in the used coupon aggregate data. If the coupon code is included, the processor 21 increases the number of times of use, which is paired with the coupon code, by “1”. If the coupon code is not included in the used coupon aggregate data, the processor 21 adds pair data of the coupon code and the number of times of use “1” to the used coupon aggregate data.

The processor 21, which finished updating the used coupon aggregate data in this way, proceeds to ACT 216. On the other hand, if coupon data added with the flag indicating that the coupon data has been used is absent in the sales promotion process data, the processor 21 determines NO in ACT 213, skips the processes in ACT 214 and ACT 215, and proceeds to ACT 216. In ACT 216, the processor 21 adds a purchase point included in the sales promotion process data to a total point of the member record 721 including the member code acquired in the process in ACT 212. The processor 21 ends the sales promotion process data receiving process.

The sales promotion code 51 displayed on the communication terminal 40 of the consumer is read by the scanner 60 of the POS terminal 10 as explained in detail above. Consequently, the processor 11 of the POS terminal 10 can collectively acquire the member code and the coupon data. The processor 11 can provide privileges such as price-cut or discount by the coupon data and additional granting of a point to the consumer identified by the member code.

Therefore, if a consumer, who is a member, uses a coupon, which is a privilege of the member, in related art, operation for presenting a member code using the communication terminal 40 and operation for presenting a coupon using the communication terminal 40 are requested. However, in at least one embodiment, the sales promotion code 51 only has to be presented. Therefore, the consumer does not feel the operation complicated. Since the operation of the store clerk is simplified, the store clerk does not feel the operation as a burden.

In at least one embodiment, if a commodity specified by the coupon data is not included in commodities purchased by the consumer, the presence of the unused coupon data is informed by the image 80. If the consumer may proceed with the settlement, the consumer presses the “YES” button 81 of the image 80, whereby the settlement process is executed. On the other hand, if the consumer cancels the settlement, the consumer presses the “NO” button 82 of the image 80, whereby the collective cancellation process is executed.

In this way, according to at least one embodiment, if a commodity specified by the coupon data is not included in the commodities purchased by the consumer, the consumer is informed to that effect. The consumer can easily select whether to proceed with or cancel settlement.

### Second Embodiment

A second embodiment is explained with reference to FIGS. 14 to 17.

FIG. 14 is a schematic diagram illustrating a data structure of a member record 722 in a second embodiment. In the member record 722, data of a customer rank is added to the member record 721 in the first embodiment. The customer rank is a rank of a consumer corresponding to a state of use of a store by the consumer.

In the second embodiment, the sales promotion server 20 includes a data table 73 having a data structure illustrated in FIG. 15. In the data table 73, a store visit point is correlated with the customer rank and set. In at least one embodiment, as a value of the customer rank decreases, a consumer is higher in a rank. The data table 73 is formed such that the store visit point is larger as the customer rank is higher.

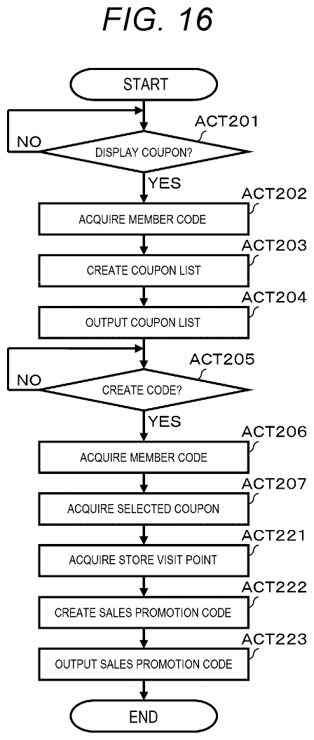

FIG. 16 is a flowchart illustrating a main procedure of a sales promotion code creating process executed by the processor 21 of the sales promotion server 20 in the second embodiment. Process acts common to the process acts of the sales promotion code creating process in the first embodiment illustrated in FIG. 6 are denoted by the same reference signs. That is, the sales promotion code creating process in the second embodiment is different from the sales promotion code creating process in the first embodiment in a process after the coupon code is acquired from the code creation command in ACT 207.

In ACT 221, the processor 21 acquires a store visit point. That is, the processor 21 searches through the member database 72 with the member code acquired in ACT 202 and detects the member record 722 including the member code. The processor 21 refers to the data table 73 with the customer rank included in the member record 722 and acquires the store visit point correlated with the customer rank.

In ACT 222, the processor 21 creates a sales promotion code 52. The sales promotion code 52 is a code in a two-dimensional code scheme. An example of the sales promotion code 52 is illustrated in FIG. 17. The sales promotion code 52 illustrated in FIG. 17 is a sales promotion code created for a consumer who selects, from the coupon list, the coupon CPa of the commodity specified by the target commodity code A and the coupon CPb of the commodity specified by the target commodity code B. As illustrated in FIG. 17, the sales promotion code 51 includes a member code, the target commodity code A and discount or price-cut information A of the coupon CPa, the target commodity code B and discount or price-cut information B of the coupon CPb, and a store visit point correlated with a customer rank of the consumer.

In ACT 223, the processor 21, which finished creating the sales promotion code 52, outputs data including the sales promotion code 52 to the communication terminal 40 which is a code creation command transmission source. Consequently, the data including the sales promotion code 52 is transmitted to the communication terminal 40 which is the code creation command transmission source via the second communication network 32. As a result, the sales promotion code 52 is displayed on the touch panel of the communication terminal 40. Therefore, the consumer confirming the sales promotion code 52 performs shopping in the store. If finishing the shopping, the consumer goes to a register, presents the sales promotion code 52 to a store clerk together with commodities to be purchased, and performs payment.

In the second embodiment, a basic operation of the POS terminal 10 is the same as the basic operation in the first embodiment. However, if calculating the purchase point in ACT 152 in FIG. 10, the processor 11 adds the store visit point included in the sales promotion code 52 to the purchase point.

In this way, in the second embodiment, the store visit point, which is a service point, is added to the sales promotion code 52 as information provided for a purchase action. The sales promotion code 52 is read by the scanner 60, whereby the processor 11 can provide the store visit point to the consumer who performs the purchase action.

Therefore, in the second embodiment, the same action effects as the action effects in the first embodiment can be achieved.

The embodiments of the information processing apparatus are explained above. However, such embodiments are not limited to this.

In at least one embodiment, as the information provided for the purchase action, the coupon data for providing the privilege of price-cut or discount to one commodity is illustrated. The information may be coupon data for providing a common privilege of price-cut or discount to a plurality of commodities.

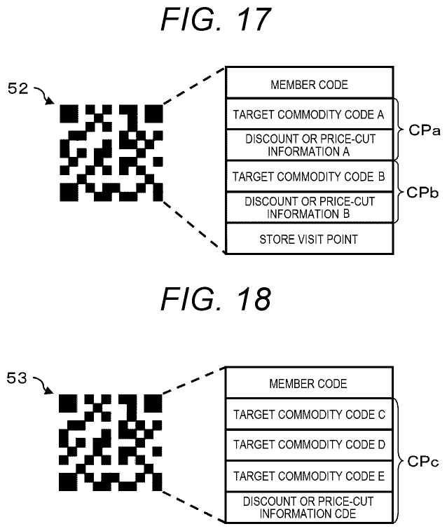

FIG. 18 is an example of a sales promotion code 53 in the case in which such coupon data is adopted. The sales promotion code 53 is a sales promotion code created for a consumer who selects, from the coupon list, a coupon CPc of the commodity specified by the target commodity code A, the commodity specified by the target commodity code B, or a commodity specified by a target commodity code C. As illustrated in FIG. 18, the sales promotion code 53 includes a member code, the target commodity code C, a target commodity code D, and a target commodity code E, and discount or price-cut information CDE common to respective commodities.

The information provided for the purchase action is not limited to the information provided from the store and may be coupon data or the like provided from a manufacturer of a commodity, a municipality, or the like.

In at least one embodiment, as an example, the sales promotion server 20 creates the sales promotion codes 51 to 53. As another embodiment, the communication terminal 40 may acquire information necessary for creation of a sales promotion code from the sales promotion server 20 and create the sales promotion codes 51 to 53 according to the member application P.

In at least one embodiment, the face to face POS terminal is an example of the information processing apparatus. As another embodiment, a self-service POS terminal with which a consumer himself or herself performs registration and settlement of a purchased commodity may be an example of the information processing apparatus. Alternatively, in a semi-self-service checkout system in which a store clerk performs registration of a purchased commodity in a registration apparatus and a consumer performs settlement in a settlement apparatus, the registration apparatus or the settlement apparatus can be an example of the information processing apparatus. Further, in recent years, a system in which a consumer performs registration of a purchased commodity using a scanner and a tablet provided in a shopping cart has been put to practical use. Alternatively, a system in which a consumer performs registration of a purchased commodity using a camera function of a smartphone carried by the consumer has also been proposed. It is possible to apply the function of the information processing apparatus to such a system as well.

In at least one embodiment, the presence of the unused coupon data is informed by the image 80. Informing means is not limited to the informing by an image. For example, the presence of the unused coupon data may be informed by sound.

Besides, the several embodiments are explained above. However, various embodiments are presented as examples and are not intended to limit the scope of the disclosure. These new embodiments can be implemented in other various forms. Various omissions, substitutions, and changes can be made without departing from the spirit of the disclosure. These embodiments and modifications of the embodiments are included in the scope and the gist of the disclosure and included in the disclosure described in claims and the scope of equivalents of the disclosure.

What is claimed is:

1. An information processing apparatus comprising:
a processor configured to:
acquire a code, the code including first data for identifying a consumer and second data for specifying information to be provided for a purchase action;
acquire the first data and the second data from the code acquired by the processor; and
provide the information specified by the second data, which was acquired by the processor together with the first data, to the consumer identified by the first data acquired by the processor.

2. The apparatus according to claim 1, wherein
the information is information relating to a privilege associated with a commodity, and
the processor is configured to provide the information relating to the privilege associated with the commodity purchased by the consumer with the purchase action.

3. The apparatus according to claim 1, wherein
the information is information relating to a service point, and
the processor is configured to provide the service point based on the information to the consumer who performs the purchase action.

4. The apparatus according to claim 1, wherein the code includes a sale promotion code for a commodity sale.

5. The apparatus according to claim 1, wherein the code includes a member code for identifying a consumer as a member.

6. The apparatus according to claim 1, wherein the code includes a coupon code for identifying a commodity for price reduction.

7. The apparatus according to claim 1, wherein the processor is configured to cause a prompting of a consumer to create a code.

8. The apparatus according to claim 7, wherein the created code includes a member code and a coupon code.

9. An information processing apparatus comprising:
a processor configured to:
acquire a code, the code including first data for identifying a consumer and second data for specifying information relating to a privilege associated with a commodity;
acquire the first data and the second data from the code acquired by the processor; and
provide the information relating to the privilege associated with the commodity when a commodity, the commodity specified by the second data acquired by the processor together with the first data, is included in commodities purchased by the consumer identified by the first data acquired by the processor.

10. The apparatus according to claim 9, the processor further configured to, when the commodity, which is specified by the second data acquired by the processor together with the first data, is not included in the commodities purchased by the consumer identified by the first data acquired by the processor, inform the consumer that the commodity is not included in the commodities purchased by the consumer identified by the first data acquired.

11. A control method for an information processing apparatus, comprising:
acquiring a code, the code including first data for identifying a consumer and second data for specifying information to be provided for a purchase action;
acquiring the first data and the second data from the code acquired; and
providing the information specified by the second data acquired together with the first data to the consumer identified by the acquired first data.

12. The method according to claim 11, wherein
the information is information relating to a privilege associated with a commodity, the method further comprising providing the information relating to the privilege associated with the commodity purchased by the consumer, the commodity purchased by the consumer with the purchase action.

13. The method according to claim 11, wherein
the information is information relating to a service point, and the method further comprising providing the service point based on the information to the consumer who performs the purchase action.
